(19) United States
(12) Patent Application Publication
(10) Pub. No.: US 2004/0265777 A1
(43) Pub. Date: Dec. 30, 2004

(54) Gingival retraction devices with a structural backing component to reliably insert retraction material into the gingival crevice

(76) Inventor: John M. Heasley, Iowa City, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/603,641

(22) Filed: Jun. 25, 2003

(51) Int. Cl. A61C 5/14

(52) U.S. Cl. 433/136

(57) ABSTRACT

Improved gingival retraction devices having a structural backing component which transmits simultaneous circumferential vertical forces to insert gingival retraction material into the gingival crevice.

### BACKGROUND OF THE INVENTION

This patent disclosure relates generally to devices and methods of improving the retraction of gingival tissues and controlling blood and fluids around teeth in order to take a more accurate and reliable impression of the teeth to be restored prosthetically. Dental impressions provide a negative likeness of prepared teeth from which dental models are constructed in the process of fabricating dental prostheses such as crowns, bridges, abutments, veneers, and the like. In order to make a dental prosthesis which will properly seal at the tooth-prosthesis interface, it is first necessary to make a high quality dental impression, a negative likeness of the anatomical detail, which registers all of the detail of the prepared tooth or teeth. The margins of prosthetic preparations, where the tooth-prosthesis interface is located, are almost exclusively in or around the gingival sulcus, an area of dental anatomy which is obscured by surrounding tissues, which frequently bleed following instrumentation. Clinical failure of a dental prosthesis is principally caused by seepage at this interface, with plaque accumulation beneath the margin and subsequent decay around the margin and beneath the crown, bridge, or abutment. The quality, or lack thereof, of the finally constructed prosthesis can usually be traced back to the quality, or lack thereof, or the dental impression which guided the subsequent steps of construction of the prosthesis. The subject of this patent disclosure, therefore, concerns improved devices and methods of the retraction of gingival tissues, the improved control of bleeding and exudation of fluids during impression taking, and subsequent improvement of the impression vehicle itself.

The most widely accepted method and device used in dentistry in order to retract gingival tissues and control bleeding in order to improve the quality of dental impressions is the application of gingival retraction cord sequentially pressed into the gingival sulcus with a hand instrument after the preparation of a tooth or teeth for prosthetic re-construct-ion. Gingival retraction cord is generally a woven or non-woven or braided fabric cord, often impregnated with hemostatic agents such as astringents and/or vasoconstrictors which cause a cessation of bleeding. Gingival retraction cord is sequentially pressed into the gingival sulcus around the tooth by the clinician with a hand instrument designed for this purpose. The manual packing force compresses the cord into the gingival sulcus; with the result that the compression after a period of time pushes the free marginal gingival tissues away from the surface of the tooth. This retraction of gingival tissues opens the sulcular space and exposes the margins of the prepared tooth. A second function of the retraction cord is to apply mechanical pressure to bleeding gingival tissues in order to stop bleeding. It has long been known in medicine and dentistry that the application of pressure to a bleeding wound causes a cessation of bleeding long enough for platelets to adhere to blood vessels and for clotting to occur and the wound to be physiologically sealed by the body. A third function of gingival retraction cord is to act as a carrier of hemostatic agents and astringents which adjunctively aid in the control of bleeding.

One of the shortcomings of the use of gingival retraction cord in preparation for dental impression taking, is that it is generally difficult to place in and around the gingival sulcus. The cord may be pressed into the sulcus by the operator only to be pulled back out in subsequent packing motions. Vertical forces are sequentially applied perpendicularly to the axial length of the cord in order to pack it into the crevice. In the process of applying this pressure to force the cord into the sulcus, the dentist attempts to eliminate or minimize axial tensile forces adjacent to sections of the cord which has already been placed. Axial tensile forces in the cord are undesirable because they cause displacement of segments of the cord that have already been packed into place. The ability to pack gingival retraction cord is truly one of dentistry's more demanding tasks, and requires an expertise which the practitioner must become proficient in order to provide quality prosthetic treatment. A second drawback of the use of gingival retraction cord is that its placement is often painful to the patient. The sequential packing of each increment of cord is accompanied by pressure on the gingiva, which often is perceived as painful sensation by the patient in spite of the area being anesthetized prior to placement of the cord. In the prior art application of gingival retraction cord, a diameter of thickness of cord is chosen, and cut to length for the anticipated circumference of the tooth being prepared for a crown or bridge abutment. The retraction cord may have any of a number of hemostatic or asyptic agents integrally applied to it, or these agents may be manually applied at the time of use of the cord. When the cord is circumferentially lodged into the gingival sulcus around the tooth, the pressure of the cord laterally against the free marginal gingiva over a period of a time retracts the tissues away from the tooth, exposing the margin of the preparation for the prosthesis. In addition, the application of pressure of the cord against the tissues and the hemostatic agents applied to the cord cause a cessation of bleeding in the sulcus. These combined actions allow impression material to be injected into the gingival sulcus during impression taking and maximize the clinician's efforts to take an accurate impression. Generally after preparing a tooth or teeth for a crown or bridge, bleeding is present in the sulcus. This is usually due to laceration of the cutting instrument used to prepare the teeth, but may vary widely with the clinician's technique and the health of the gingival tissues at the time of preparation. The packing of retraction cord into a bleeding sulcus requires an almost traumatic application of pressure to tissues already traumatized by prior procedures. Often, this causes even more bleeding to occur as the cord is placed. This prior art method is highly technique-sensitive and is not easily mastered by clinicians, often producing unpredictable results.

The invention of improved gingival retraction devices consists of devices which may be inserted into the gingival sulcus in a single motion with finger pressure by the direct transmission of vertical forces circumferentially through the rigidity of the structural backing component to laterally displace the gingival tissues around a tooth. Devices of this nature replace the sequential use of a hand instrument to incrementally force a retraction cord into the sulcus. Further, the devices eliminate the axial displacing tensile forces of the cord technique which dislodge the cord from sulcular areas where it has already been pressed into place, since the devices are circumferentially contiguous by design, eliminating the transmission of axial or circumferential forces.

An alternative use for the gingival retraction shells and bands described in this disclosure pertains to their use as impression copings for single die impressions of individual teeth. The impression copings are incorporated into an overall arch impression and left in place upon polymerization of the material. While this technique in and of itself is not novel and was initially known as the Pagenkopf Technique, which is described by Tylman et al in Theory and Practice of Crown and Bridge Prosthodontics, fifth edition, 1965, published by C.V Mosby Co., the embodiments of the gingival retraction shells and bands described in this disclosure, with their integrally attached porous fabric or mesh material, which will micro-mechanically bond with impression materials of all types, thus obviating the need for adhesive application to obtain attachment of the copings to the overall arch impression, is novel.

A product by the trade name of Comprecap, by Roeko, Inc. has recently been introduced to the dental profession as an aid in the retraction phase prior to taking impressions. Comprecap is basically an absorbent, dome-shaped absorbent product, fabricated with cotton or other natural fibers. Manufacturer's instructions advise using the product in conjunction with dental retraction cord. The technique involves the clinician packing dental retraction cord into the sulcus in the usual prior art method, then placing a Comprecap over the prepared tooth and having the patient bite down on it while the dentist waits for the cord to retract the gingival tissues. The product's main function is to absorb blood and fluids and to insure that the retraction cord stays in place during the waiting period. Comprecap has no internal malleable or rigid shell, being manufactured entirely of a non-woven fiber, and therefore lacks the adaptability, rigidity, and specificity of application to be pressed accurately into the gingival sulcus and to replace the use of retraction cord in the process of gingival retraction prior to the taking of impressions. In addition, Comprecap is not designed to act as a carrier or vehicle for the new hemostatic and retraction pastes that are currently being marketed under names such as Expa-Syl gingival retraction paste by Kerr or Gel Cord tissue management gel by Pascal.

A company by the name of Pascal has marketed a product called Retra Rings, elastic retraction rings which are to be pressed down into the gingival sulcus in order to retract the gingival tissues by the use of mechanical pressure alone. These devices do not have a fabric or porous mesh attached in which to serve as a matrix for the application of hemostatic agents to be applied to control gingival bleeding. In addition, the nature of the elasticity of the rings makes them prone to sliding upwards if stretched around the prepared tooth, which invariably takes on a truncated conical shape after preparation for a crown or bridge abutment. This tendency to displace from the sulcus frustrates the essential goal of placing a device into the sulcus which will stay in place for a period of time to allow for mechanical retraction of the tissues and also allow the chemical agents to provide hemostasis. An additional shortcoming of these elastic rings is that when they are stretched around a tooth, the elastic memory tends to return the ring to a generally planar shape, regardless of the variable contours of the gingival sulcus. This product has not met with success in the marketplace in replacing the dominant technique of the application of retraction cord as the principal means of gingival retraction.

Yet another product that has recently appeared on the market are Retracta-Loops, marketed by Dental Innovations, which is essentially a fabric retraction cord which is a loop of dental retraction cord, combined with a cinching device which allows the loop to be variably adjusted for size around a tooth. This product is virtually the same as the linear retraction cord which is marketed by most manufacturers and duplicates the retraction cord method of gingival retraction. Placement is by cinching the cord around a tooth, then tightening the loop until it circumferentially squeezes the cord down into the sulcus around the tooth. U.S. Pat. No. 5,899,694, Gingival Retraction Apparatus and Method, issued May 4, 1999, to John Summer, and U.S. Pat. No. 5,480,303, Gingival Retraction Cord Tool, issued Jan. 2, 1996, to Eric Groth, are very similar devices in the prior art. Both describe retraction cord loops which are applied with a cinching device which allows the loop of cord to be adjusted in circumference. These patents describe an approach to using gingival retraction cord which would not be effective in retracting the sulcus and would be far too cumbersome to be practical.

U.S. Pat. No. 3,541,689, Gingival Retraction Ring, issued Nov. 24, 1970, to Wilford A. Snead, describes a gingival retraction collar which is moved down over a tooth until the bottom contours of the device are inserted subgingivally. The retraction collar described has tabs which may be folded down after the collar is in place around a tooth in order to retract the gingival tissues, and also so as not to interfere with the impression. The retraction collar remains in place while the impression material is applied and polymerizes. The device described functions purely as a mechanical device only, and makes no reference to the device being a vehicle for the administration of any retractive or hemostatic agents, chemicals, or medications; whether integrally applied during manufacture or manually applied by the clinician.

U.S. Pat. No. 3,151,393, Dental Impression Taking Device, issued Oct. 6, 1964 to H. M. Holmes, describes a purely mechanical device which functions in a similar manner to U.S. Pat. No. 3,541,689. This device is a centrally open, cup-like collar having an upwardly diverging generally conically shaped configuration and a lower edge adapted to a tooth around a subgingival margin. The device functions to retract the gingiva and serve as a barrier during impression taking. This device, like the '393 patent, is a purely mechanical device which makes no reference to being a vehicle for the administration of any retractive or hemostatic agents; integrally applied during manufacture or manually applied at the time of use.

U.S. Pat. No. 2,958,946, Device for Taking Impressions, issued Nov. 8, 1960, to Jack O. Chertkof, describes yet another purely mechanical device, similar in function to both the Snead and Holmes patents previously described. The embodiment is of a generally cylindrical form with a downwardly converging series of tapered ends, which are said to be adaptable to a tooth in the subgingival area. No mention is made to the addition of any retractive or hemostatic agents which would enhance gingival retraction or control bleeding during the taking of an impression.

U.S. Pat. No. 4,892,482, Dental Retraction Cord, issued Jan. 9, 1990, to Michael P. Lococo, describes a gingival retraction cord composed primarily of a braided fabric, with a copper wire placed within it; the copper wire comprising 1/16^{th} of its mass. The copper wire serves as a malleable element which is said to provide the cord with deformability so that the cord can be bent and remains in its bent or deformed state. This device is an alternative embodiment of the predominant fabric gingival retraction cord method of gingival retraction. This cord is applied in exactly the same manner as any other gingival retraction cord, with a sequential packing motion into the gingival sulcus, until the cord is applied circumferentially. While this patent does have a malleable element within it, the malleable element is not integrally attached to the fabric mesh cord elements which allows the cord to slide and ‘bunching up’ longitudinally along the copper wire as pressure is applied to press it into the sulcus, thus failing to completely eliminate the cause of the cord from being displaced from the sulcus as it is applied by the dentist or clinician. Essentially just a variation of gingival retraction cord, the application of the device follows the prior art method of sequentially pressing the cord into the sulcus by repetitive hand motion. There is no method for the simultaneous transmission of force perpendicular to the cord for simultaneous insertion into the gingival sulcus, nor is there any discussion of the need for the malleable element being integrally attached to the retraction fabric.

U.S. Pat. No. 4,531,914; Dental Device and Method for Gingival Retraction and Conditioning, issued Jul. 30, 1985 to Ronald P. Spinello, Westbury, N.Y., describes a method and apparatus for “swiftly performing gingival retraction and conditioning in which a mass of moldable coherent plastic, preferably thixotropic is lightly pressure molded into and around the gingival trough of a prepared tooth to apply substantially balanced forces around the gingival flap . . . to effect an enlargement of the trough . . . ” This patent does not claim the invention of retraction devices such as shells, bands, rings, or tape which may be specifically adapted to precisely fit into the gingival sulcus or “trough”, but instead, patents a moldable material with strengthening fibers which is molded over a prepared tooth and gingival area in order to force retraction material into the gingival sulcus. Although the process does mention the use of pressure to force retraction material into the sulcus, the process recited is quite different than the gingival retraction devices described in this disclosure. The ultimate goal of retracting the gingival tissues is sought, but the means and method employed is substantially different than the adaptation of malleable retraction devices specifically to the contours of the gingival crevice.

U.S. Pat. No. 3,238,620, Method of Preparing an Impression of a Tooth, issued Jun. 22, 1961, to L. C. Peterson, describes a retraction ring of absorbent, resilient material of uniform cross-sectional shape which may be forced over the margins of a prepared tooth and into the gingival sulcus in order to retract the gingival and stop bleeding in order to obtain a detailed impression of the tooth in order to construct a crown or abutment for a bridge. The disclosed retraction ring is composed of a generally resilient material in order to expand to a circumference larger than the manufactured size and thus adjust to an individual tooth. The shortcoming of the use of a resilient material for this purpose is that the ring wants to return to its original unstretched size and therefore has a rebound effect of displacement from the gingival sulcus.

WIPO application number WO 02/102269 entitled Gingival Retraction Device and Method, filed Jun. 17 2002 by Coopersmith of Montreal, Quebec Canada describes a retraction loop to retract the gingival tissues around a tooth in order to prepare for taking an impression. The loop is said to be preferably deformably rigid, extensile, non-elastic, compressile, and absorbent. The Coopersmith application is narrowly focused on embodiments of loops only and does not recite devices which are shells, domes, caps, crown forms, bands, tapes, rods or cords. The loops disclosed are said to be sequentially packed into the gingival crevice with a conventional hand instrument 124, as shown in FIGS. 5, 9, and 10. Although a crown form 112 is depicted in multiple drawings, as stated on page 11, line 36, 37 the crown form is said to be “a provisional restoration 112 (which) has been fabricated by conventional means from a dental impression to register with the prepared tooth 100”. In a method cited in the disclosure, this provisional crown form is used to push a retraction loop into the gingival sulcus by the patient biting down on it. The sequence of events required to fabricate a provisional crown by the methods described are (a) preparation of the tooth for a crown or abutment, (b) the taking of an impression to form a negative likeness of the prepared tooth, (c) taking an impression to register the occlusion the opposing teeth, (d) pouring a dental stone model from the impression which is a positive likeness of the prepared tooth, (e) pouring a stone model of the opposing teeth, (f) preparing a provisional crown with acrylic resin or a similar material, and (g) refining the provisional crown restoration so that it adapts to the margins of the prepared tooth. The amount of time required to accomplish all of these steps and create the provisional crown for this retraction technique is at least a couple of hours, includes laboratory preparation, and in most cases would require the patient being re-scheduled for the retraction and impression appointment. This is an inefficient use of time, in as much as conventional retraction methods usually only require about 10 minutes to perform, immediately after preparation of the tooth. As stated on page 11, line 37 to page 12, line 2, the provisional restoration “has an interior surface 114 and a margin 116 that are together configured to conform to the tooth abutment 102 and the tooth margin 104. This means that the final edges of the provisional crown are flush with the sides of the tooth circumferentially. When the crown is fully seated, the margins of the crown absolutely will not go past the margins of the preparation of the tooth and into the gingival sulcus, thus failing to actively push the retraction loop effectively into the gingival sulcus, in spite of all of the time expended in preparing the provisional crown. Coopersmith does not recite at any place in his patent application the preparation of a shell, dome, cap, or crown form with margins that extend beyond the margins of the prepared tooth and into the gingival sulcus. In addition, Coopersmith does not recite the integral attachment of any type of retraction material to a shell, dome, cap, crown form, band, tape, rod, or cord in his disclosure. Coopersmith emphatically states that linear forms of devices are not within the spirit and scope of his disclosure, ruling out retraction tapes, rods, and cords. Although Coopersmith discusses the simultaneous application of two types of materials as an alternative embodiment of his retraction rings, he completely fails in his graphic renderings and in his discussion to inform the reader what form and configuration these embodiments would consist of. Coopersmith makes a vague reference to the two material embodiments as disparate materials which are either to be mixed homogeniously or to consist of layers. If a device is to consist of layers, the reader is left wondering if the loops are to be concentrically layered or to be planar laminates, what specific materials are to be included in the two layering concept, which layer is placed against the tooth and which is placed in contact with the gingival tissues, and the contribution of characteristics that each layer provides. There is not even a single cross-sectional form of a two material layer retraction ring anywhere in the graphic renderings.

### SUMMARY OF THE INVENTION

The invention consists of a series of retraction shells, bands, rings, and tape which function to actively retract gingival tissues and control bleeding prior to taking dental impressions for the purpose of construction of a dental prosthesis. The retraction shells fall into two general categories based on their structural backing component; malleable, and flexible. The devices may come in a variety of shapes and forms, including shells, (also called domes or caps), bands, rings, linear tape, or rod forms. Among the embodiments of shells, are truncated conical forms, cylindrical dome forms, and also organic crown forms. The shell forms are open on one end only, while the band and ring forms are open-ended on both ends. The retraction devices function as improvements in the art of gingival retraction by the manner in which they utilize simultaneous vertical forces perpendicular to the circumferential perimeter to insert the devices into the gingival sulcus. This varies from the prior art in the manner in which retractive materials are sequentially pressed into the gingival crevice with a hand instrument prior to the taking of impressions. The improved retraction devices are composed generally of a structural backing component with enough rigidity to be forcefully inserted into the gingival sulcus while maintaining enough malleability or flexibility to be bent to conform to the external circumferential form of a prepared tooth. Generally attached to the structural backing is an integrally applied retractive layer of material such as a fabric, mesh, sponge, foam, or cork which serves to mechanically retract the gingival tissues laterally away from the tooth. Alternatively, a chemico-mechanical hydrogel or similar mechanism may be applied to the backing component to retract gingival tissues away from the tooth. If the retractive layer is a fabric or mesh material, it may be composed or either natural or synthetic fibers which are either a woven or non-woven structure. The retractive layer may or may not be impregnated with a hemostatic and/or a vasoconstrictive chemical or medication to control bleeding in the gingival crevice. The improved retraction devices may retract gingival tissues either with mechanical forces alone, or alternatively with mechanical forces and hydrostatic forces when used in conjunction with a highly viscous and/or expansive retraction paste, putty, or gel. The chemicals utilized to control bleeding may either act to induce clotting and coagulation or may alternatively act to constrict blood vessels locally to decrease blood flow to the gingival crevice. Cessation of bleeding is also achieved by the mechanical pressure applied to the gingival crevice by the retractive layer. The devices may be fabricated of varying thickness to accommodate individual preferences for gingival insertion. Some forms of the devices such as the cap, dome, or organic crown forms may lack an integrally applied retractive material, but rely instead on a manually applied retraction paste, putty, or gel applied to the interior concave surface of the shells. An improved form of gingival retraction tape, which is sectioned part of the way through its width is described which allows the tape to quickly adapt to the convexities and concavities of the gingival crevice by the use of finger pressure rather than trimming with a scissors. Finally, the improved retraction devices may alternatively be used as impression copings as single die impressions and then incorporated into the final full arch impression with micro-mechanical bonding of the exterior mesh material to the overall arch impression.

### BRIEF DESCRIPTION OF THE DRAWINGS

FIG. 1 is a drawing of a clinician seating an improved gingival retraction shell over a prepared tooth in order to retract the gingival tissues laterally away from the margins of the preparation.

FIG. 2 is a drawing of the prior art method of sequentially pressing gingival retraction cord into the gingival sulcus around the margins of a prepared tooth.

FIG. 3 is an isometric view of an improved gingival retraction shell which is open on one end of the shell only.

FIG. 4 is an isometric view of an improved gingival retraction band which may be cylindrical or conform to the cross section of a tooth in shape and is open on two surfaces.

FIG. 5 is an isometric view of a length of improved gingival retraction tape.

FIG. 6 is an isometric view of an improved gingival retraction ring.

FIG. 7 is a cross-sectional view of an improved gingival retraction device with a metal structural backing component and a porous fiber or mesh retraction material integrally attached to the backing component.

FIG. 8 is a cross-sectional view of an improved gingival retraction device with a metal structural backing component and a porous fabric retraction material integrally attached to the backing component.

FIG. 9 is a cross-sectional view of an improved gingival retraction device with a metal structural backing component and a porous sponge layer retraction material integrally attached to the backing component.

FIG. 10 is a cross-sectional view of an improved gingival retraction device with a metal structural backing component with a manually applied synthetic resin paste, putty, or gel retraction material for the hydrostatic method of gingival retraction.

FIG. 11 is a cross-sectional view of an improved gingival retraction device with a plastic or composite structural backing component and a porous fiber or mesh retraction material integrally attached to the backing component.

FIG. 12 is a cross-sectional view of an improved gingival retraction device with a plastic or composite structural backing component and a porous synthetic sponge retraction material integrally attached to the backing component.

FIG. 13 is a cross-sectional view of an improved gingival retraction device with a plastic or composite structural backing component and a superabsorbent hydrogel retraction material integrally attached to the backing component.

FIG. 14 is a cross-sectional view of an improved gingival retraction device with a plastic or composite structural backing component and a manually applied a paste, putty, or gel retraction material for the hydrostatic method of gingival retraction.

FIG. 15 is an isometric view of a container of an assortment of varying sizes and forms of improved gingival retraction shells for application to molars, premolars, canines or icisors.

FIG. 16 is a drawing of a clinician cutting the margins of an improved gingival retraction shell with a scissors in order for the margins to parallel the vertical contours of the gingival crevice surrounding a prepared tooth.

FIG. 17 is a drawing of a clinician crimping the margins of an improved gingival retraction shell with crimping pliers in order to adapt the margins to the horizontal contours of the gingival crevice surrounding a prepared tooth.

FIG. 18 is a drawing of a clinician pushing an improved gingival retraction shell over a truncated conical die in order to increase the circumferential diameter of the margins of the device to precisely seat the device in the gingival crevice surrounding a prepared tooth.

FIG. 19 is a drawing of a clinician manually injecting a retraction paste or gel into the interior of an improved gingival retraction shell in preparation for the hydrostatic method of gingival retraction.

FIG. 20 is a drawing of a clinician seating an improved gingival retraction shell with finger pressure over a tooth prepared for a crown or abutment.

FIG. 21 is a cross-sectional drawing of an improved gingival retraction shell with vertical forces applied to the shell to insert the integrally attached porous fabric or mesh material into the depth of the gingival crevice.

FIG. 22 is a cross-sectional drawing of an improved gingival retraction shell with vertical forces applied to the shell to hydrostatically force a manually applied gingival retraction paste or gel specifically into the depths of the gingival crevice.

FIG. 23 is a drawing of a clinician injecting a gingival retraction paste through a hole in the gingival retraction shell in an enhanced hydrostatic method of forcing gingival retraction paste or gel specifically into the depths of the gingival crevice.

FIG. 24 is a cross-sectional drawing of the syringe tip inserted into the top of a gingival retraction shell of FIG. 23, injecting gingival retraction paste or gel under pressure through the seated gingival retraction shell and into the depths of the gingival crevice.

FIG. 25 is an isometric view of an improved gingival retraction band seated into the gingival crevice of a prepared tooth.

FIG. 26 is an isometric view of an improved gingival retraction ring seated into the gingival crevice of a prepared tooth.

FIG. 27 is an isometric view of a length of gingival retraction tape seated circumferentially around the circumference of the gingival crevice of a prepared tooth.

FIG. 28 is an isometric view of a short length of gingival retraction tape inserted into the labial gingival crevice of a tooth prepared for adhesive bonding of a porcelain laminate restoration.

FIG. 29a-c are views of a length of an alternate embodiment of an improved gingival retraction tape which allows the tape to automatically adapt to the contours of a gingival crevice with finger pressure and without trimming with scissors.

FIG. 30 is a view of a gingival retraction shell used for an alternative purpose as an impression coping allowing an individual die impression to be taken initially, and then incorporated into an overall arch impression.

FIGS. 31a and 31b are an isometric and a cross-sectional view of an improved gingival retraction rod with a fibrous mesh material integrally attached to the axial structural backing component, respectively.

FIGS. 32a and 32b are an isometric and a cross-sectional view of an improved gingival retraction rod with a hydrogel retraction layer within an external porous membrane, respectively.

FIGS. 33a-g are isometric cross-sectional views a malleable metal inner structural backing integrally bonded to retraction material in a variety of alternative configurations.

### DETAILED DESCRIPTION OF THE PREFERRED EMBODIMENTS

For the purposes of the discussion, vertical seating forces are forces parallel to the longitudinal axis of a tooth in the direction of the end of the root. Lateral forces are forces perpendicular to the longitudinal axis of the tooth and perpendicular to the outer circumference of the tooth, away from the central axis. Gingival retraction requires the lateral retraction of the free marginal gingival away from the surface of a tooth. Axial forces within a gingival retraction cord are forces along its length. Undesirable forces within the prior art gingival retraction cord are axial tensile forces which cause sections of a cord already placed in the gingival crevice to be displaced. Circumferential forces within the improved gingival retraction devices are forces within the device along the axis of the gingival crevice, which circumferentially surrounds a tooth.

Shell Forms:

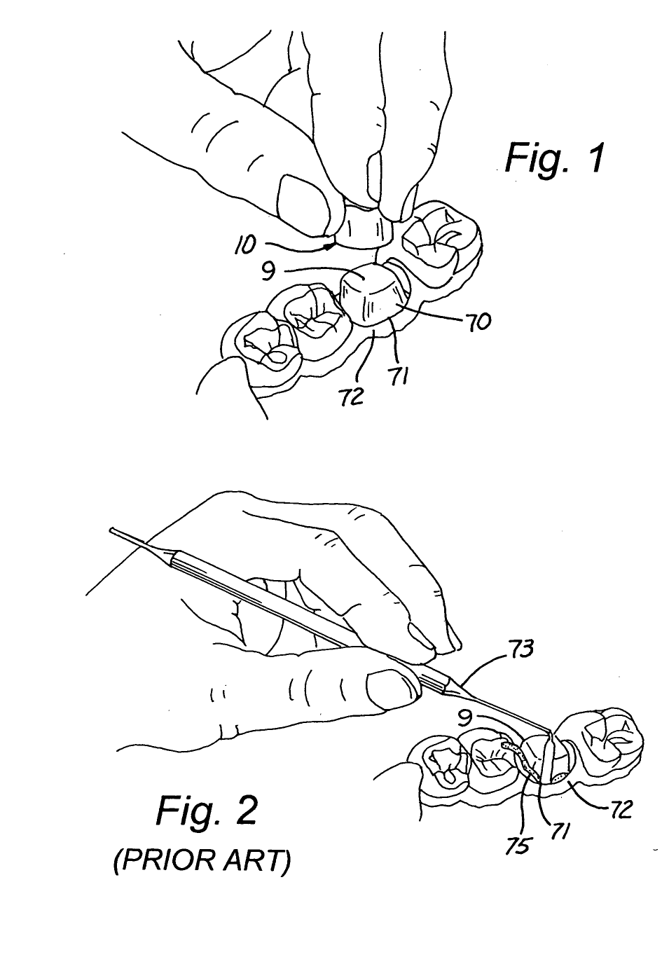

FIG. 1 demonstrates a clinician is placing an improved gingival retraction shell as shown generally at 10 over a tooth prepared to receive a crown 70 in order to insert the margins of the gingival retraction shell into the gingival crevice 71 circumferentially surrounding the tooth and bordering the inner surface of the free marginal gingiva 72. FIG. 2 demonstrates the prior art of packing gingival retraction cord 75 into the gingival crevice 71 with a cord packing instrument 73. This prior art method involves the sequential insertion of sections of the retraction cord 75 incrementally around a tooth until the retraction cord completely encircles the gingival crevice 71 in order to laterally retract the free marginal gingiva 72 laterally away from the tooth to expose the margin of the preparation of the tooth (not shown in FIG. 1).

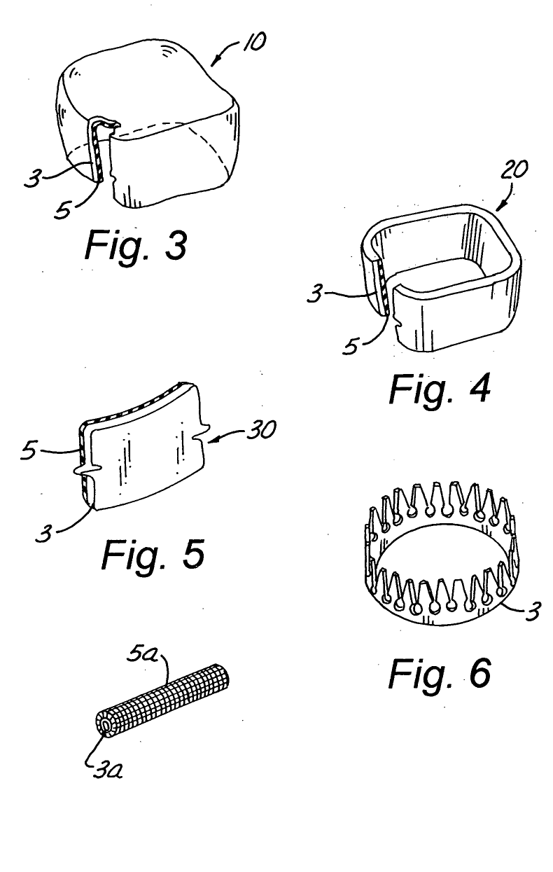

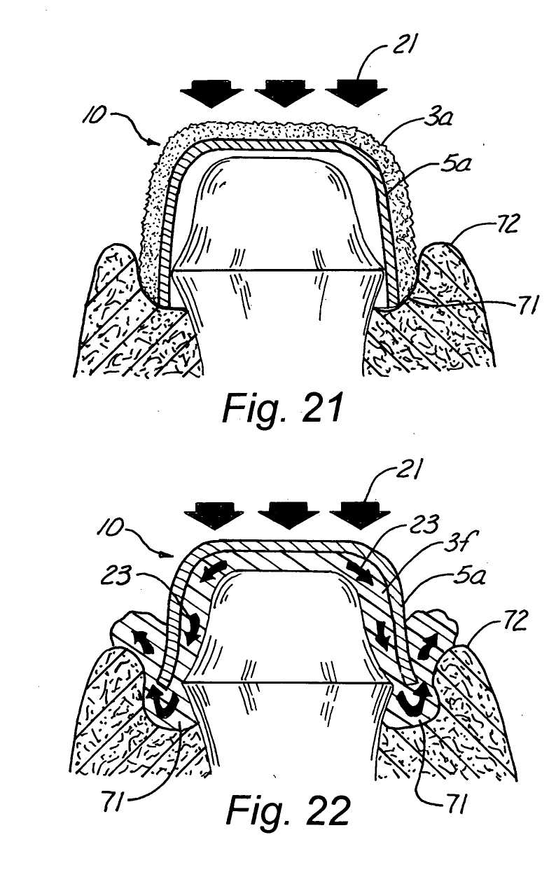

The improved gingival retraction devices of this disclosure may consist of a number of alternative forms. As shown in FIG. 3 generally at 10, gingival retraction shells (also called caps, dome, or crown forms) have one open side for insertion over a prepared tooth. A small cut-away section in the side of the retraction shell of FIG. 3 shows the inner structural backing component 5 with a gingival retraction material 3 integrally attached to the outside of the structural backing component. FIG. 21 is a cross-sectional view of a shell form of gingival retraction device shown generally at 10 with an integrally attached porous fibrous mesh material 3a bonded to the outside of the retraction shell. In this embodiment, the vertical seating forces 21 transmit force through the malleable metal structural backing component 5a. Since the retraction material is integrally bonded to this element, the seating forces insert the retraction material into the gingival crevice 71 (the words gingival crevice and gingival sulcus have the same meaning). The retraction material, initially compressed and under pressure, laterally retracts the free marginal gingival away from the tooth, thus exposing the margin of the preparation when the retraction device is removed. In addition to retraction of the gingival, the pressure of the retraction material aids in the cessation of bleeding in the gingival crevice. In addition, the retraction material may be impregnated with hemostatic agents which facilitate clotting and vasoconstrictive agents chemicals which constrict regional blood flow to the sulcular area.

As shown in FIG. 22, when a contiguous closed shell form is filled with a viscous retraction paste or putty and forcefully seated over a prepared tooth (arrows show vertical seating forces 21), the containment chamber generates hydrostatic forces within the retraction resin or paste 7. Hydrostatic forces are shown as resultant vector forces represented as arrows 23 within the shell indicating the magnitude and direction of flow of the material under pressure. The external vertical forces cause the resin material 5a to flow down a pressure gradient, forcing gingival retraction resin into the gingival crevice 71 and forcing the free marginal gingival 72 laterally away from the tooth. In addition to hydrostatic retraction, the flow of material carries blood and crevicular fluids out of the gingival crevice 71.

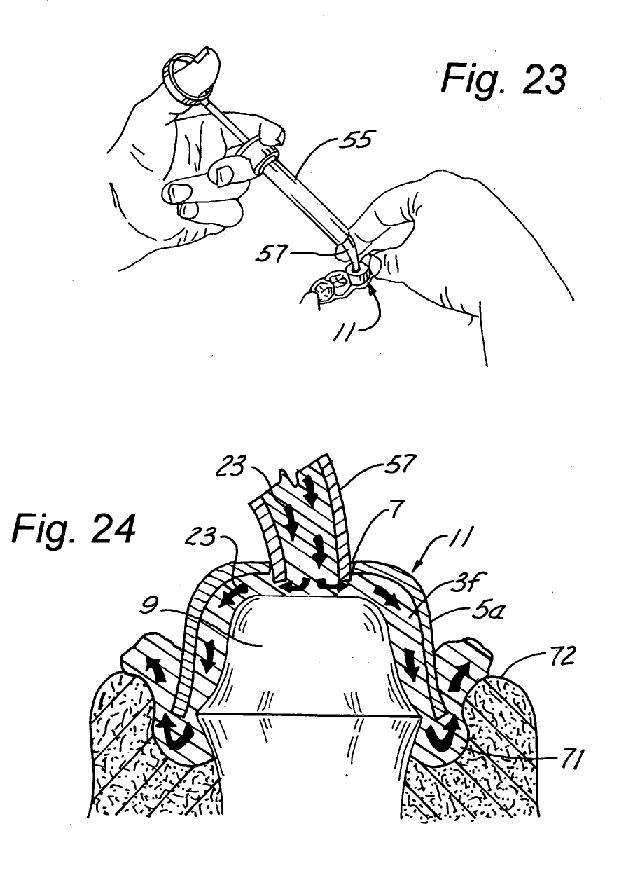

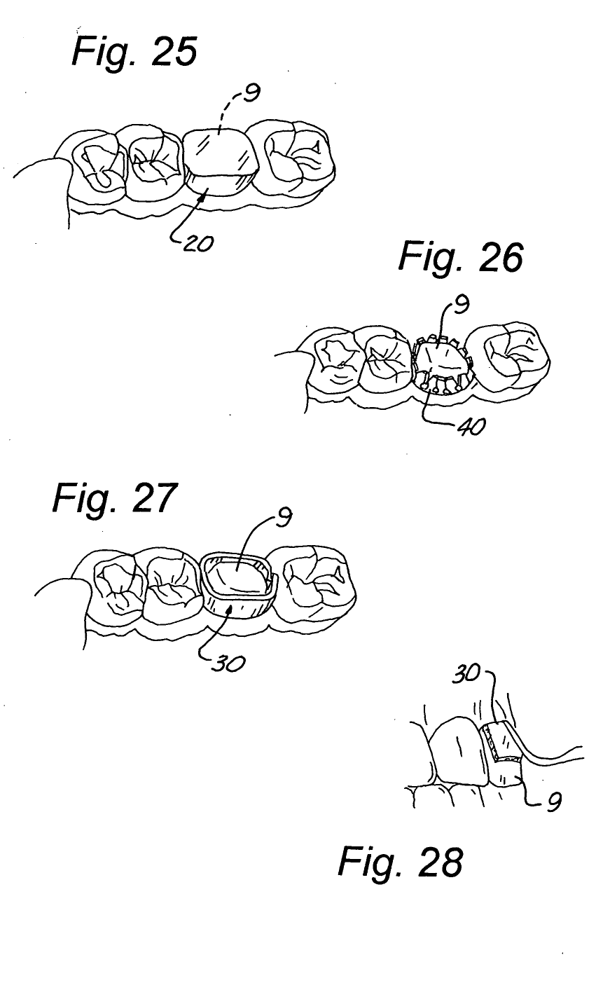

FIG. 23 and FIG. 24 show an enhanced hydrostatic method of gingival retraction utilizing a slightly modified embodiment of gingival retraction shell, shown generally at 11, in which the shell is provided with a hole 7 on the top surface of the shell which complements the diameter of a syringe tip 57 provided for the technique. In this embodiment, gingival retraction resin 3f is forcefully injected with the syringe 55 into the seated retraction shell 11. The resultant hydrostatic forces 23 cause the resin to flow from the syringe tip 57 to the interior of the shell, down the sides of the prepared tooth and into the depths of the gingival crevice 71. As the paste or gel is exiting the gingival crevice, the flow of the resin flushes out blood and crevicular fluids. The viscous consistency of the retraction resin aids in retraction of the free marginal gingival 72 laterally away from the tooth to expose the margin of the preparation when the retraction device is removed.

Band Forms:

A band form of improved gingival retraction device is shown in FIG. 4 generally at 20. A small cut-away section of the band reveals the inner structural backing component 5 and the outer gingival retraction layer 3. The band form is open at both ends and may be cylindrical or a form generally paralleling a cross-section of the type of tooth that it is designed for. Due to the malleable or flexible qualities of the inner structural component, whatever general manufactured form is provided may be easily modified by the clinician at chair-side.

Ring Forms:

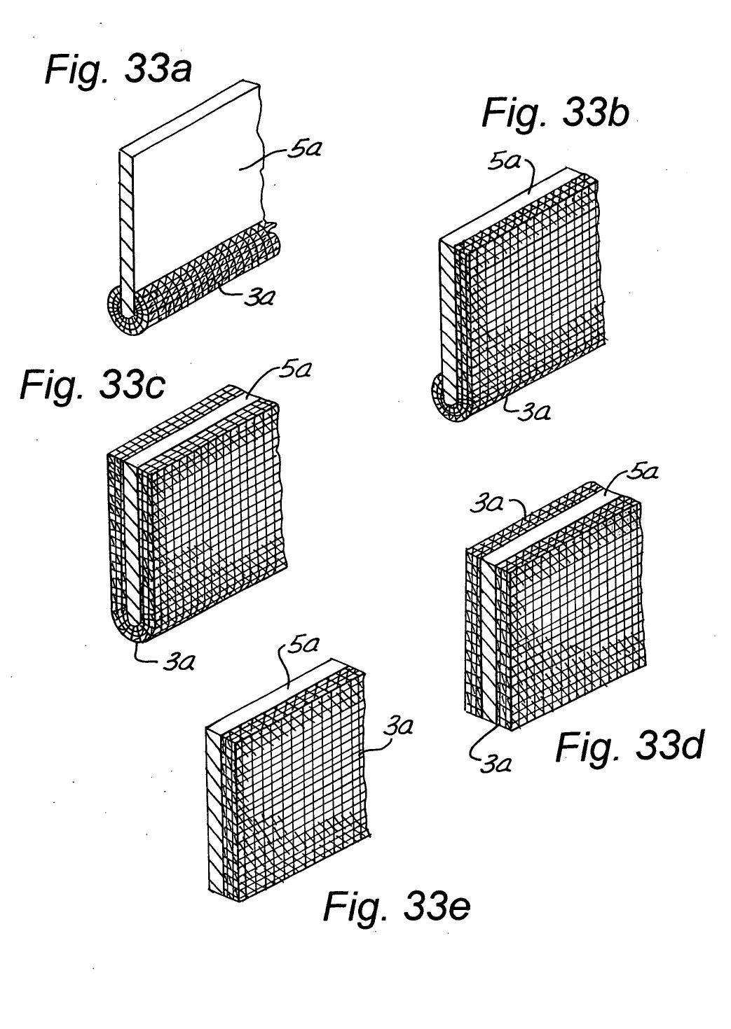

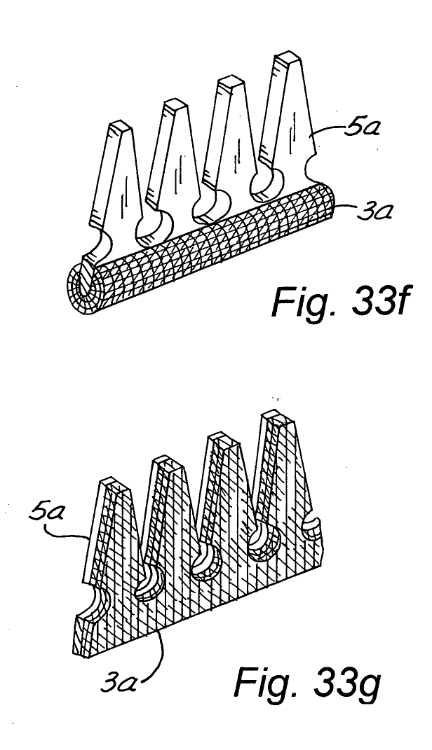

FIG. 6 shows a ring form of improved gingival retraction device generally at 40, sectioned partially throughout its width which allows the dentist to insert the ring with finger pressure and adapt it to the convexities and concavities of the gingival crevice. FIGS. 33a-g show a cross-section section demonstrating a malleable metal inner structural backing component 5a, and the outer retraction ring layer 3a integrally bonded to the structural backing component 5a. FIG. 33a shows a concentrically wrapped functional end, while FIG. 33b shops a laminar structure of retraction material 3a bonded to the structural backing component 5a. This configuration of a retraction ring allows the functional retraction element to be deformed in the horizontal plane as well as the vertical plane, for three-dimensional adjustment to the gingival crevice. It also allows the dentist to insert the device into the gingival sulcus with finger pressure alone, by transmitting the vertical seating forces along the structural backing component to carry the retraction material into the gingival crevice. Other forms of the ring embodiment with a malleable metal axial structural component 5a with a round or concentric cross-section and an outer circumferential gingival retraction layer 3a are demonstrated graphically. Any laminar or other cross-sectional configuration or different material composition of the layers of the ring form 40 of improved gingival retraction device may be considered an alternative embodiment.

Tape forms:

FIG. 5 shows a linear gingival retraction tape generally at 30 with an inner structural backing component 5 and an outer retraction layer 3 integrally bonded to it. This embodiment has both a versatility of applications and accommodates high volume manufacturing processes which make it an attractive embodiment for commercial production at low production costs and subsequent low costs to the end-user. The layers of the retraction tape may be joined by a simple lamination technique and coiled on spools for easy dispensing to the end-user. If a malleable structural backing component is utilized, the tape can be easily bent to parallel the curvature of any preparation.

FIG. 27 illustrates the way in which a retraction tape can be circumferentially bent to completely engage the gingival crevice around a prepared tooth. Due to the width and rigidity of the retraction tape, finger pressure along is sufficient for pressing the retraction tape into the gingival crevice. FIG. 28 shows a short length of retraction tape generally at 30 inserted into the facial sulcus to retract tissues selectively on just the facial side of the tooth in order to obtain an impression for porcelain laminates to be constructed. Since the margins of some preparations are simultaneously both above and below the gum line, as in the case of onlays, complete circumferential retraction is not always needed. Gingival retraction tape can be cut to length to accommodate a variety of the clinician's needs.

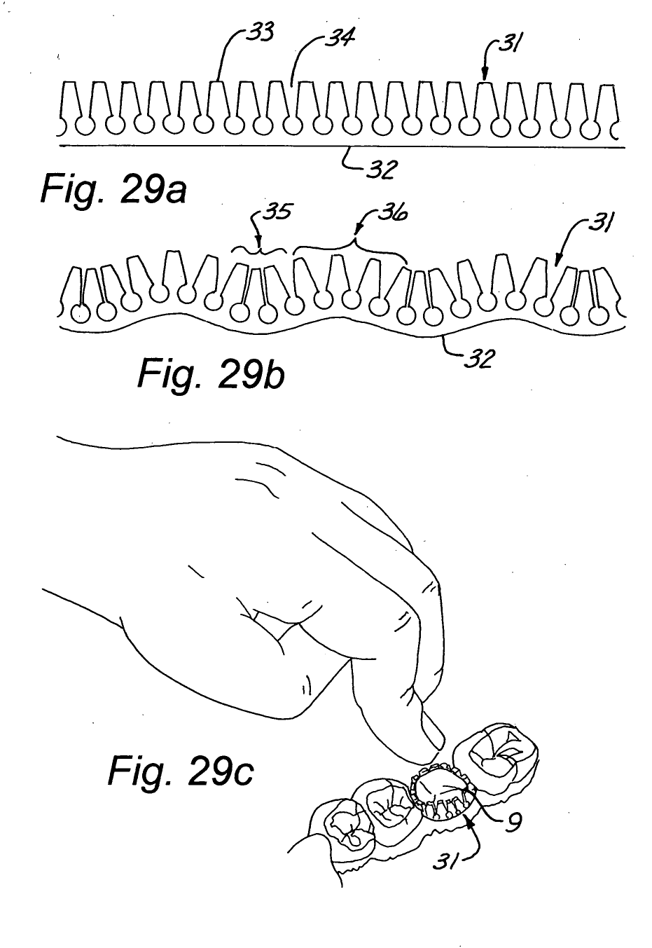

FIGS. 29a through 29c illustrate a unique alternative embodiment of gingival retraction tape, shown generally at 31. Shown in FIG. 29a, this embodiment has a functional side of the tape 32 to be inserted into the gingival crevice is manufactured as a straight linear tape surface. As in all of the other devices described, in the manufacturing process the structural backing component 5 is bonded to a retraction material layer 3. The tape is then die-cut or blanked into a repetitive pattern of trapezoidal sections 33 at regular intervals with spacing 34 between the sections while the functional side of the tape is left intact. This pattern allows the functional side 32 of the tape to be easily bent into convex or concave curvatures which parallel the individual curvatures of the gingival crevice of a tooth. By pressing on the series of truncated sections, the spacing between the sections closes 35 and the functional surface of the tape becomes convex. By pressing the tape over a convex gingival crevice section, truncated sections are spread out 36 creating greater spaces between the sections and the functional surface 32 of the tape becomes concave in order to parallel the contours of the gingival crevice. FIG. 29c shows a clinician pressing this alternative embodiment of tape 31 into the gingival crevice 71 around a prepared tooth.

Rod Forms:

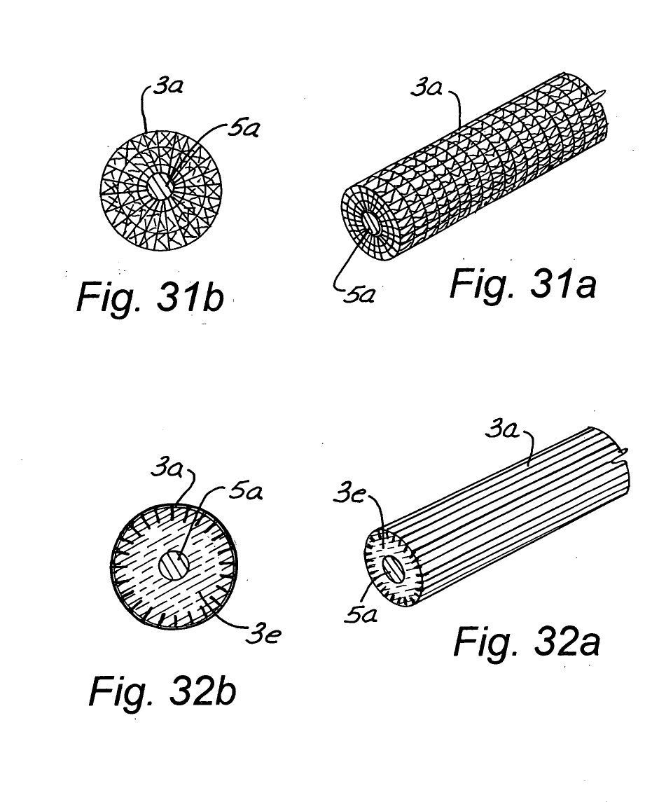

The rod form of improved gingival retraction devices, illustrated in FIGS. 31 a-b and FIGS. 32a-b, has a structural backing component 3a of generally malleable material which is an axial cylindrical core with a generally concentric cross-sectional configuration and an outer circumferential gingival retraction layer 5a surrounding the inner concentric structural component which is integrally bonded to the central core. The integral bonding of these two components is essential, so that the outer retraction material layer cannot slide freely along the central core and ‘bunch up’, causing displacement of the device as the retraction rod is placed into the gingival crevice. The deficiency of the gingival retraction cord disclosed in U.S. Pat. No. 4,892,482, Dental Retraction Cord, issued Jan. 9, 1990, to Michael P. Lococo, with an inner the copper wire comprising 1/16^{th} of its mass and braided fabric around this central element, as cited in the prior art analysis of this disclosure, is that the inner malleable element is not integrally attached to the surrounding loosely braided fabric. This allows the braided fabric to slide along the copper wire and ‘bunch up’ longitudinally along the copper wire as pressure is applied to press it into the sulcus. This design flaw causes this type of retraction cord to fail to completely eliminate axial tensile displacing forces which are the cause of the cord from being displaced from the sulcus as it is applied by the dentist or clinician. The circumferential retraction material layer 5a in an effective axial device must either be integrally bonded to the internal axial structural backing member 3a or at the very least be so tightly wrapped around the structural member 3a that frictional forces prevent the outer layer 5a from sliding longitudinally along the inner member 3a when subjected to the forces of placement of the tube into the gingival crevice. In the alternative embodiment illustrated in FIGS. 32a-b, a hydrogel 3e is included between the structural member 3a and the outer layer 5a.

Just as FIG. 27 shows a length of gingival retraction tape seated circumferentially around the circumference of the gingival crevice of a prepared tooth to achieve much the same effect as the band form of a gingival retraction device, the rod form of retraction device may also be cut to length so as to be circumferentially placed in the gingival sulcus to achieve much the same effect as the concentric ring form of retraction device. Shorter lengths of this form of device may be utilized for gingival retraction of only a portion of the circumference of a tooth as in the case of porcelain laminates.

The variations of diameter of the circumferential rod forms (as well as all the variations of form of the improved gingival retraction devices) of retraction devices generally will parallel the diameters of gingival retraction cords which are commercially available.

The Method of Adapting a Circumferential Improved Gingival Retraction Device to Precisely Fit into the Gingival Crevice of a Tooth

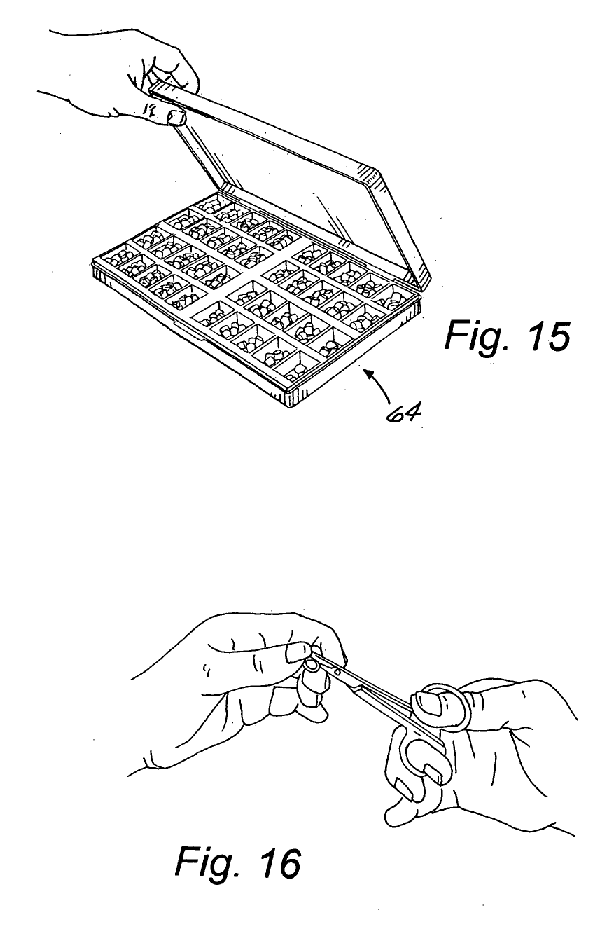

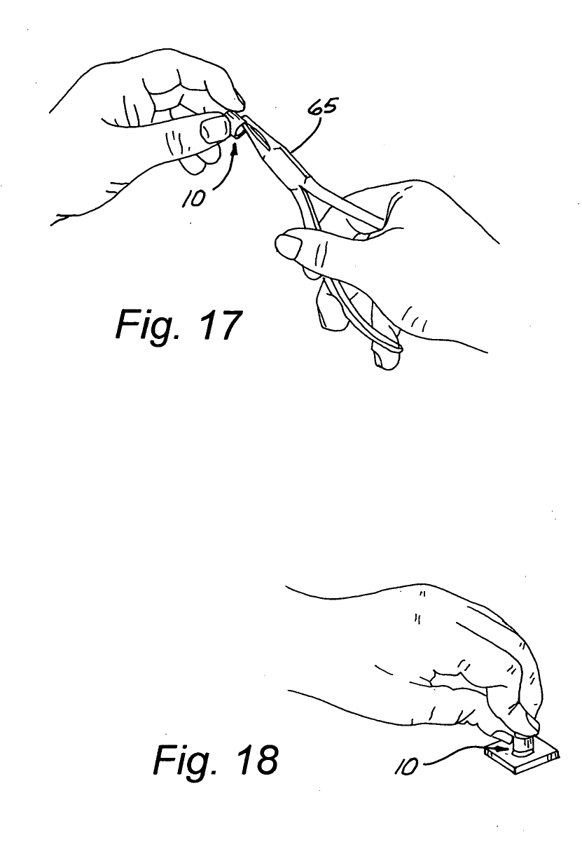

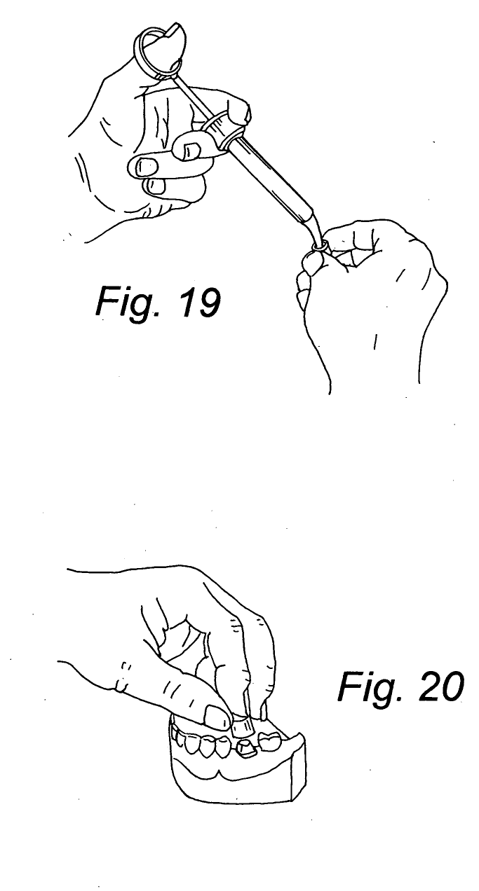

As shown in FIG. 15, improved gingival retraction devices, whether of the shell form or band or ring form, will be supplied in kits 64 which include an assortment of sizes and individual morphologies for different teeth in the mouth. When a clinician searches for the proper size of retraction shell, for instance, he or she should choose a circumferential diameter which precisely matches or is slightly smaller than the circumferential diameter of the tooth at the cross-sectional level of the margin of the preparation. The retraction shell is first placed over the prepared tooth to check the potential fit (FIG. 20). If the fit is acceptable, the clinician begins trimming excess material with a scissors as shown in FIG. 16 from the device in order to develop margins which will parallel the contours of the depth of the gingival sulcus. The clinician then may crimp the margins as shown in FIG. 17 with a crimping pliers 65 to adjust the circumferential diameter or horizontal contours of the shell 10 to the margins of the prepared tooth and gingival sulcus 71. If the circumferential diameter of the shell is smaller than that of the cross-section of the tooth, the circumferential diameter of the shell may be increased in size by pressing the open end of the shell over small truncated cylindrical dies as shown in FIG. 18. The ductility of the malleable metal or malleable plastic or composite is such that simple finger pressure is enough to enlarge the diameter. The shell is then tried on the tooth. If the circumferential diameter needs further refinement, the shell may be forcefully pressed over the prepared tooth, as shown in FIG. 20 in the same manner as pressing it over the die. If the simple retraction method of carrying integrally attached retraction material into the gingival sulcus is to be used, the shell may be further pressed past the margins of the tooth and into the gingival crevice. It is important that the dentist press the shell into the crevice gently so that the gingival tissues are not lacerated or the gingival attachment fibers are not severed. Tipping the shell as it is placed into the crevice to insert one side first and then follow with the rest of the margin of the shell is proper technique. As shown in FIG. 28, a periodontal probe or other suitable instrument may be used to precede the insertion of the margins of the shell. If the gingival retraction shell is to be used in the hydrostatic method of gingival retraction, the interior of the shell may first be filled with retraction resin as shown in FIG. 19. Both the insertion of the retraction material layer and the hydrostatic method of retraction may be utilized simultaneously if preferred by the clinician. Although this discussion focused on retraction shells only, individual principals recited also applicable to gingival retraction bands tape, and rings selectively as required.

Material Composition of Structural Backing Components

The structural backing component acts to transmit the vertical (axial forces parallel to the long axis of the tooth) forces as the retraction device is pressed into the gingival sulcus, thus carrying the retraction material into the gingival sulcus to retract the free marginal gingiva in a lateral direction away from the tooth's surface. In addition, the structural backing material must be adaptable to the individual contours of the exterior circumference of a tooth and its gingival crevice.

Gingival Retraction Devices with a Malleable Structural Backing Component

The malleable retraction devices have a structural backing component of highly malleable metal or malleable plastic or composite material. The malleable nature of these backing components allows devices composed of this type of structural element to be bent to conform to the external contours of a tooth and retain the prescribed contours with an internal memory inherent in the material without the tendency to rebound to a predetermined shape. This memory characteristic makes this type of backing the preferred embodiment for many types of the retraction devices. Generally this type of structural component will be composed of a dead-soft metal or malleable plastic or composite. If a metal is utilized, it generally will be in the annealed state in order to maintain highly malleable properties which may be manipulated easily with finger pressure. Aluminum or copper are two soft metals which are imbued with ideal characteristics for this type of application. This discussion will focus on metals used for this purpose, but extrapolation to suitable malleable plastic or composite materials should be implied as substitution for the metallic devices described.

Gingival Retraction with Malleable Circumferential Devices:

Gingival retraction with retraction shells or other types of circumferential devices is achieved by selection of the proper diameter retraction shell from a variety of alternatives supplied by the manufacturer, followed by proper adaptation of the shell for insertion into the gingival sulcus around a tooth. The gingival retraction shells or bands will be supplied in an assortment of sizes and morphologies corresponding to anatomical variations present in the dentition of the population of patients. The circumference of the retraction shell should anticipate as close as possible the circumference of the prepared tooth at the margin of the preparation for the dental prosthesis. If an error in judgment is made in the size of shell or band to be utilized, a slightly smaller than ideal size is preferable to a larger size. The retraction shell can be modified to custom fit the tooth in a variety of ways. The malleable shells may be customized to the individual anatomic contours of the tooth by a variety of methods, including: a. the crimping or festooning of the edges of the shells with the use of a crimping pliers to decrease the circumferential diameter or to engage undercuts, b. the cutting of the extremely soft, malleable material with the use of a scissors in order to adapt the margins or boundaries of the shells to the contours of the gingival crevice, c. the pressing of the malleable shells over small plastic dies in order to stretch the circumferential diameter of the open margins of the shells to the margins of the preparation, and d. the pressing of the malleable shells over the prepared tooth with pressure to refine the fit of the shells to the gingival crevice and to individually contour the shells to actual tooth contours. The malleability and ductility of characteristics of the material composition of the shells allow the clinician to easily adapt the shells to produce a customized retraction device which will insert into the gingival sulcus around the periphery of a tooth in order to systematically retract gingival tissues. Once the retraction shell is adapted to the contours of the tooth and gingival sulcus, it is inserted with finger pressure into the sulcus in a single action. As the shell is pushed down over the margins of the tooth into the sulcus, the ductility of the malleable metal allows the circumference or the shell to expand precisely to the circumference of the tooth at the margin of the preparation as it is forced into the gingival crevice. Since the malleable material stretches and bends to the desired form with the characteristic of a memory, it retains the prescribed contours without a tendency to rebound and to dislodge from the gingival crevice. The malleable material, in addition to having qualities of ductility and malleability, must also satisfy the requirement of sufficient rigidity to allow the clinician to adapt the crown for use and use circumferentially applied vertical force (finger pressure) to insert the shell forcefully into the gingival sulcus without buckling or collapsing the shell from the pressure which is generated. A vital balance between, malleability, ductility, and rigidity to allow the clinician to adapt and customize the shells or devices while maintaining structural integrity for insertion must be incorporated into their manufacture for a successful, clinically efficacious retraction device to be developed commercially.

Gingival Retraction Devices with a Flexible Structural Backing Component

Gingival retraction shells, bands, rings, or tape composed of an alternative flexible (non-malleable) backing component will generally be made of a plastic or Mylar or polyethylene or similar material with enough flexibility to easily conform to the external contours of a tooth, and yet still be rigid enough to withstand the forces required to press it into the gingival sulcus without buckling. In addition to the forces generated when pressing these devices into the gingival sulcus, the shells may be filled with a retractive paste or gel and then pressed over a prepared tooth, generating additional hydrostatic pressure of the material in the shell in order to force excess material into the gingival sulcus as it flows out of the shell. This type of backing may be more easily manufactured and is a commercially a less expensive device to manufacture. In non-circumferential devices such as the tape embodiment, where a selected length of gingival retraction material is required this type of embodiment will be quite suitable. An example of an application where gingival retraction around a section of a tooth is sufficient to obtain an intact impression are porcelain laminates. In this application, the subgingival preparation of the tooth for the laminates is predominantly on the facial surface of the tooth, extending interproximally a given distance. Short strips of gingival retraction tape may be cut to length and inserted in one motion into the crevice. An embodiment which provides the retraction layer for the facial surface while allowing the Mylar strip to be inserted in the contact areas for retention during retraction is possible either during the manufacturing process or by a method of customization of the tape at chair-side by the clinician. In addition to this application, a complete circumferential application can be achieved by cutting the tape equal to or slightly longer than the circumference of the tooth, then inserting it with the ends meeting or some overlap.

Material Composition of the Applied Retraction Layer

1. Mechanical Retraction with a Fabric or Mesh Retraction Mechanism

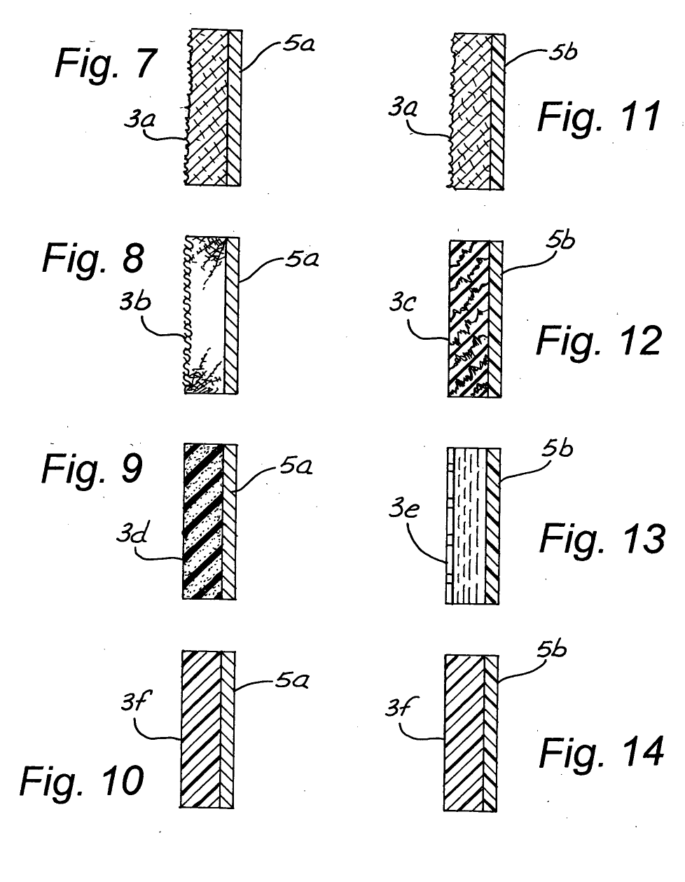

As shown in FIG. 7, the retractive layer may be composed of porous non-woven or woven fibers 3a integrally attached to a metal backing component 5a. or alternatively attached to a plastic or composite backing component 5b as in FIG. 11. Shown in FIG. 8 is a woven or braided fabric or mesh material 3b attached to a metal structural backing component 5a or alternatively a plastic backing component (not shown). The fibers of the FIG. 7, FIG. 11, or FIG. 8 may be naturally occurring fibers, or alternatively, fibers of synthetic origin. The application of these materials parallels their use in conventional retraction cord to achieve gingival retraction by physical pressure within the gingival sulcus 71 to retract the free marginal gingival tissues 72 laterally away from the exterior circumference of the tooth. Alternate substitution of materials for mechanical retraction might be a compressed synthetic sponge 3c as shown in FIG. 12, or highly porous rubber 3d as shown in FIG. 9. The overall variation of cross-sectional diameter of thickness of improved gingival retraction devices parallels the variety of diameters of retraction cords available commercially as conventional retraction cord.

2. Chemico-Mechanical Retraction with a Hydrogel

As shown in FIG. 13, the structural backing component, whether metal as in 5a or plastic or composite 5b may be integrally coated with a volume expanding hydrogel polymer 3e which increases in volume upon exposure to a predetermined environmental condition. In this application, a hydrogel applied to the retractive devices described herein is generally a superabsorbent polymer which absorbs water or bodily fluids, producing a chemico-mechanical expansion of the material, which forces the free marginal gingiva laterally away from the surface of the tooth, thus exposing the margins of the preparation for the impression phase of construction of a crown, abutment, or prosthesis in order to obtain a clear registration of the details of the prepared tooth. One such embodiment of an external coating is a superabsorbent acrylic fiber which is a copolymer of polyacrylic acid and polyammonium acrylate with a core of ployacrylo-nitrile. This material is capable of absorbing many times its weight in liquids and swells to many times its original volume, and in so doing so, mechanically retracts the gingival tissues laterally away from the surface of the prepared tooth. There are other formulations of hydrogels and volume expansive materials, and so the discussion herein should not be construed to be limited only to the specific formulation(s) cited. The super-absorbent hydrogel may be composed of a single polymer network or alternatively of a co-polymer, whether a random, alternating graft or block co-polymer. The rate of hydration of the polymer (and therefore the expansion rate) may be controlled by pore size of an external membrane, if the material is contained by a membrane, or alternatively by the degree of cross-linking if a copolymer not contained within a permeable membrane.

In general, by changing the gel hydrophobicity, polymer-solvent interactions are affected, influencing the solvent diffusion rate and the plastification rate. The control of hydrogel expansion by the hydrogel itself permits the design of apparatuses with specific absorption and expansion rates without the need for an exterior containment membrane. Determination of the degree of cross-linking and properties of a polymer gel network are described, for example, by Peppas et. Al. (eds) in “Hydorgels in Medicine and Pharmacy” Vol 1, CDC Press, Boca Raton, Fla., 1986. If a device is designed with a containment membrane, the pore size directly affects the rate of hydration and expansion. A gingival retraction device so designed would preferably have a pore size which allows water, crevicular fluids, and blood to be freely absorbed, while constraining the hydrogel from leaving the device through the pores. In addition, ideal pore size would allow the simple diffusion of hemostatic agents, vasoconstrictors, and medications through the membrane into the sulcus and into contact with gingival tissues. There are advantages and disadvantages in the design of devices with or without exterior containment membranes, notably that if a containment membrane is absent the hydrated gel needs to be flushed out of the gingival crevice after application of the device, while the device with a membrane obviates the need for removal of gel. This is largely an inconsequential disadvantage, however, since a water flush of the crevice after any retraction device is removed is advisable under any circumstance to remove dried and clotted blood and contaminants prior to taking an impression.

3. Hydrostatic Retraction With Manually Applied Retraction Putty, Pastes, or Gels

FIG. 10 and FIG. 14 show a retraction resin 3f of a putty, paste, or gel manually applied to the structural backing component, whether of metal 5a or plastic or composite 5b composition which is applicable to the hydrostatic method of gingival retraction. The embodiment of retraction device which facilitates this type of application is preferably the shell form of device, although the gingival retraction band may also suffice if a finger is placed over one end of the band to contain the material and force it into the gingival crevice as it is applied. In this method, a retraction shell which is filled with a retraction putty, paste, or gel as shown in FIG. 19 and forced over the prepared tooth as shown in FIG. 20. A cross-sectional view of this method is shown in FIG. 22. A gingival retraction shell 10 is filled with retraction resin 3f and pressed over a prepared tooth with vertical pressure (arrows over the shell) in the same manner in which a single die impression is taken. As the volume of the prepared tooth displaces volume of retraction gel, it creates hydrostatic forces (small arrows in the retraction resin) which expel the material specifically into the gingival crevice 71 with a specificity that flushes out blood and debris in its wake. The completely seated retraction device then allows the paste or gel begin to polymerize while impregnated hemostatic agents diffuse into the gingival tissues to stop bleeding into the sulcus. If the retraction paste or putty is composed of a superabsorbent hydrogel, the absorption of fluids creates expansion of the material and lateral displacement of the gingival tissues. In addition, the polymerized retraction material secures the retraction to the tooth and prevents accidental dislodgement of the device during the waiting period. Removal of the device after a period of time accomplishes a cessation of bleeding, removal of fluids, and exposure of the margins of the prepared tooth due to gingival retraction. Another embodiment of this type of retraction device as shown in FIG. 23 and FIG. 24 may consist of an alternative embodiment of a gingival retraction shell 1 with a hole or orifice located within the cylindrical end of the device. A syringe tip 57 is placed into the hole to actively inject retraction paste or gel into a previously seated gingival retraction device. The hydrostatic pressure (small arrows within the injected resin) created by the active injection of this material allows a greater volume of material to flush out fluids from the gingival crevice 71 in largely the same manner as previously described.

The Application of Hemostatic and/or Vasoconstrictive Agents

Achieving hemostasis within the gingival sulcus is one of the major goals of the pre-impression preparation. The need for control of bleeding is of equal importance to the need for retraction of gingival tissues away from the tooth to expose the gingival margins of the prepared tooth. Prior art methods of gingival retraction rely on manually packing the retraction cords into the gingival sulcus in order to mechanically compress gingival tissues, while administering vasoconstrictive and/or astringent agents simultaneously. In general, there are three types of mechanisms for achieving hemostasis: The first is the application of mechanical pressure to tissues in order to compress capillaries and vascular elements to stop bleeding so that platelets may adhere to vascular walls and seal leakages. The second is the application of chemical vasoconstrictors in order to constrict vascular elements, thereby slowing down or stopping blood flow locally to the affected tissues, epinephrine being the most widely used agent in this class. The third is the application of chemical agents such as astringents or clotting factors to chemically promote the clotting of blood in the gingival sulcus, such as hemostatic agents such as aluminum sulfate, aluminum potassium sulfate, zinc phenol-sulfate, ferric sulfate, epinephrine, or a combination of the aforementioned agents. Hemostatic and/or vasoconstrictive agents may be added to the shells at the time of their manufacture or manually by the end-user in order to chemically achieve hemostasis within the gingival crevice. Alternatively, vasoconstrictors may be employed to constrict localized vascular elements, thereby slowing down or stopping blood flow to the region. Fourth, by hemostatic and astringent agents integrally applied to the porous retractive layer of the shells at the time of manufacture, or by the incorporation of these agents into manually applied hemostatic pastes, putty, or gels applied to the shells by the clinician at the time of use.

An Alternative Application of Gingival Retraction Shells as Impression Copings

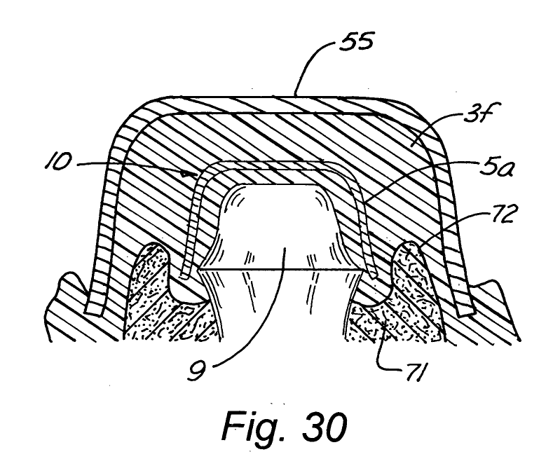

As shown in FIG. 30 alternatively the retraction shells of applications shown in FIG. 10 and FIG. 14 may be used directly during the impression phase as single die impressions which are seated and left over the prepared teeth and then incorporated into an overall arch impression after primary gingival retraction and hemostasis has been accomplished as a separate step. In this application, retraction shells further function to retract gingival tissues by a hydrostatic or hydraulic pressure, by forcing viscous dental impression material under pressure into the gingival sulcus as the retraction shell is seated on the prepared tooth 9 by the clinician. The seating of the retraction shell, overfilled with impression material, not only creates pressure within the viscous material, but causes the excess material to flow outwardly, displacing the gingival tissues as it flows out of the sulcus 71. The retraction shells, coated on one or both sides by a woven or non-woven fiber, fabric, or mesh, attaches the impression material to the shells by micro-mechanical bonding of the polymerized material when it finally sets up. The retraction shells with the single tooth impression may be removed as a single die impressions, or the clinician may choose to cover both the seated retraction shell and the whole arch with an impression tray 55 filled with impression material 3f, to complete a whole arch impression. In this application, the impression material contacting the outer side of the retraction shell bonds with the fabric mesh to form micro-mechanical bonds to lute the impression shell 5a to the impression material in the tray. The retraction shell is integrated into the final impression and becomes an integral part of it.

With respect to the previously described embodiments, it is to be realized that the general relationships for the parts of the invention are illustrative of the function and manner of operation of said invention, and the assembly and use of said invention should be readily apparent and obvious to one skilled in the art. Further, since numerous modifications and changes will readily occur to those skilled in the art, it is not desired to limit the invention to the exact construction and operation shown and described, and accordingly, all suitable modifications and equivalents may be resorted to by the inventor, as falling within the scope and spirit of the invention. Merely listing the steps of a method in a certain order does not constitute any limitation in the order of the steps of a method. The foregoing description and drawings merely explain and illustrate the invention, and the invention is not limited thereto, except in so far as the claims are limited. Those skilled in the art who have the disclosure before them will be able to make modifications and variations therein without departing from the spirit and scope of the invention.

Improved gingival retraction shells, bands, rings, or tape should always be used in conjunction with a rubber dam to prevent aspiration or ingestion of these small devices and components. The gingival retraction devices may serve yet another purpose as devices which apply medications such as antibiotics, anesthetics, anti-inflammatory medications, and osteogenic agents, to list a few. These agents may be integrally applied to the devices at the time of manufacture or alternatively be applied manually by the end-user. The ease with which these devices may be inserted into the gingival crevice make them excellent candidates for a variety of treatment modalities for various intra-oral diseases and conditions.

I claim:

1. Improved gingival retraction devices, comprising a structural backing component which transmits simultaneous circumferential vertical forces to insert gingival retraction material into the gingival crevice.

2. The improved gingival retraction devices of claim 1, wherein the structural backing component is of malleable composition.

3. The improved gingival retraction devices of claim 1, wherein the structural backing component is of a resilient or flexible composition.

4. The improved gingival retraction devices of claim 1, wherein the retraction material is integrally attached to the structural backing component at the time of manufacture.

5. The improved gingival retraction devices of claim 1, wherein the retraction material is manually applied to the structural backing component by the end-user.

6. The improved gingival retraction devices of claim 4, wherein the structural backing component transmits vertical forces to the integrally attached retractive material to effectively insert the retraction material into the gingival sulcus.

7. The improved gingival retraction devices of claim 4, wherein the integral attachment of these two components eliminates undesirable axial or circumferential tensile displacing forces, thereby making insertion of the improved retraction devices easier and more predictable for the end-user.

8. The improved gingival retraction devices of claim 1, wherein the retraction devices is of a form selected from the group consisting of shells or domes, cylindrical bands, rings, organic crown forms, linear tape form, or rod forms.

9. The malleable improved gingival retraction devices of claim 2, wherein the structural backing component comprises a malleable metal selected from the group comprising aluminum, copper, brass, tin, and gold, alloy of such metals, and malleable plastics or composites.

10. The gingival retraction shells of claim 5, wherein the shells are filled with a retraction putty, paste, or gel for the application of a viscous hydrostatic mechanism of gingival retraction.

11. The gingival retraction shells of claim 1, wherein the gingival retraction shells are manufactured with integrally applied hemostatic or vasoconstrictive agents to promote the cessation of bleeding.

12. The method of adjusting and adapting the improved malleable gingival retraction devices of claim 2, wherein the size, form and contours of the devices are altered by a clinician to customize the fit of the devices so that they insert precisely in the gingival crevice of a tooth .

13. The method of claim 12, further comprising plastic frustoconical dies and wherein the clinician increases the circumferential diameter of the opening of the soft, malleable material of the shell, band, or ring by forcing it over the plastic frustoconical dies.

14. The method of claim 12, wherein the clinician further increases the circumferential opening by forcing the shell over the prepared tooth.

15. The method of claim 12, further comprising a hand forceps and wherein the clinician bends or crimps the shells with hand pressure by using the crimping forceps to decrease the external circumference or to alter the contours of the margin of the shells.

16. The method of claim 12, further comprising a scissors and wherein the clinician cuts or trims the soft metal of the margins on the shells with the scissors in order to adapt the margins of the malleable shells to parallel the contours of depth of the gingival sulcus.

17. The malleable gingival retraction shells of claim 2, wherein the malleable material is sufficiently malleable to be adapted by finger pressure while being sufficiently rigid to transmit vertical forces required to insert the retraction devices into the gingival sulcus without collapsing or buckling.

18. The flexible gingival retraction devices of claim 3, wherein the structural backing component comprises a flexible plastic, Mylar, or composite which retains flexibility and adaptability while being sufficiently rigid to withstand the vertical forces required to insert the retraction device into the gingival sulcus.

19. The gingival retraction devices of claim 4, further comprising a structural backing component and wherein the retraction material is integrally attached to the outer surface of the structural backing component or alternatively to both the inner and outer surface of the structural backing component.

20. The gingival retraction devices of claim 4, wherein the retraction material comprises a porous fabric, mesh, or foam material of non-woven or woven, natural or synthetic composition which mechanically retracts the gingival tissues laterally away from the tooth.

21. The gingival retraction devices of claim 4, wherein the retraction material comprises a superabsorbent hydrogel which absorbs water and bodily fluids and undergoes a chemico-mechanical volume expansion which retracts the gingival tissues laterally away from the tooth.

22. The gingival retraction devices of claim 11, wherein the hemostatic agents minimize or eliminate blood flow to the gingival tissues.

23. The improved gingival retraction devices of claim 1, further comprising impression material applied to the malleable shells or bands to form individual die impressions of single teeth that may be used as impression copings of an arch impression.

24. The alternative application of gingival retraction shells of claim 23, further comprising a porous fabric or mesh material and wherein the porous fabric or mesh material forms a micro-mechanical attachment with the impression material upon polymerization of the impression material.

25. The method of claim 12, further comprising manual application of retraction resin or alternatively impression material to the inside of the shell and seating of the shell over the prepared tooth with vertical force which forces the gingival retraction material or impression material into the depths of the gingival sulcus by generating hydrostatic pressure.

26. The method of claim 12, further comprising injection of gingival retraction resin or alternatively impression material into the shell through a hole in the top of the shell with a syringe engaging the hole to create additional hydrostatic pressure within the shell to flush fluids and debris out of the gingival crevice and to force retraction material or impression material into the depths of the gingival crevice by generating hydrostatic pressure.

27. The gingival retraction devices of claim 21, wherein the hydrogel comprises either a single polymer network or a co-polymer.

28. The gingival retraction devices of claim 21, wherein the hydrogel comprises a mat layer attached to the structural backing component without an external porous membrane or alternatively a mat or gel with an external porous membrane.

29. The gingival retraction devices of claim 21, wherein the rate of absorption and expansion may be controlled by either the degree of cross-linking if a co-polymer is utilized, or by another function of the chemical reaction, or alternatively by the pore size of an external membrane.

30. An alternative embodiment of the linear tape form of gingival retraction tape in which the tape is sectioned in a manner in which the functional retractive surface of the tape may be adapted to horizontal convexities and concavities of the gingival crevice quickly with finger pressure, instead of trimming the tape with a scissors.
